(19) United States
(12) Patent Application Publication
(10) Pub. No.: US 2002/0108060 A1
(43) Pub. Date: Aug. 8, 2002

(54) Method and apparatus for login authentication

(76) Inventors: Chikaharu Takamoto, Hyogo (JP); Toyoharu Shimada, Hyogo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/836,180

(22) Filed: Apr. 18, 2001

(30) Foreign Application Priority Data
Dec. 11, 2000 (JP) 2000-375406 (P)

(51) Int. Cl. H04L 9/32

(52) U.S. Cl. 713/201; 709/217

(57) ABSTRACT

A user transmits, from an on-premises terminal or an off-premises terminal, his/her user ID and password as well as an address of a web page that the user attempts to access. A login authentication apparatus receives them and determines whether the received user ID, password and address of the web page match any of those stored in an authentication table within its master file. If they match, the login authentication apparatus transmits the address of the web page to a proxy server, so that the user is allowed to access the desired web page. Accordingly, the login authentication system ensures security on a web page basis within a web server, and the operation of the user is simplified.

### BACKGROUND OF THE INVENTION

1. Field of the Invention

The present invention relates to apparatuses and methods for login authentication, and more particularly, to a login authentication apparatus connectable with a terminal and a web server through an intranet and a login authentication method therefor.

2. Description of the Background Art

In accordance with advances of information technologies in recent years, intranets have been vigorously established in corporate organizations.

Of those having established their intranets, large-scale companies often place web servers in respective business offices or factories, or respective divisions or departments, centered on their headquarters.

For the purpose of ensuring security, these multiple web servers perform authentication management independently from one another, by requiring respective users to input their user IDs and/or passwords. This means that, when a user repeatedly accesses the multiple web servers on performance of the job, the user must input his/her user ID and password every time he/she attempts to access a new web server. This makes the user operation laborious and complicated.

Further, since each web server has a plurality of web pages, it is desired from the standpoint of guaranteeing security that the authentication management be performed on a per-page basis. However, if the authentication is managed not only on a per-server basis but also on a per-page basis for all the web pages within all the web servers, the user operation will become extremely painstaking and intricate, and the cost for the authentication management will considerably increase. Thus, the authentication management has been performed on a web server basis, with that on a web page basis relinquished.

Conventional methods for authentication on networks have been proposed in Japanese Patent Laying-Open No. 10-177552 and Japanese Patent Laying-Open No.10-105516. However, they do not teach techniques to ensure security on a web page basis within a web server. In addition, those authentication systems are not intended to be built in an environment for intranet.

### SUMMARY OF THE INVENTION

An object of the present invention is to provide an apparatus and a method for login authentication that assures web page-based security for a respective web server within an intranet and that allows a simple operation for a user.

The login authentication apparatus according to the present invention is connectable to a terminal and a web server through an intranet, and includes: a storage unit that stores a user identifier, an address of a web page within the web server readable by a user having the user identifier and an address of a web page within the web server changeable by a user having the user identifier; and an authentication unit that compares a user identifier received from the terminal with the user identifier stored in the storage unit to determine whether a user having the user identifier received from the terminal is allowed to read the web page and whether the same user is allowed to change the web page.

Preferably, the storage unit correlates the user identifier with the web page readable or changeable by a user having the user identifier, and stores them in a table.

Accordingly, it becomes possible to ensure security on a web page basis, instead of a web server basis, and laborious and complicated operations including inputting user ID and password for every web page become unnecessary.

The login authentication method according to the present invention utilizes a login authentication apparatus connectable to a terminal and a web server through an intranet. The method includes the step of storing a user identifier, an address of a web page within the web server readable by a user having the user identifier and an address of a web page within the web server changeable by a user having the user identifier; and the step of comparing a user identifier received from the terminal and the user identifier stored in the storing step to determine whether a user having the user identifier received from the terminal is allowed to read the web page and whether the same user is allowed to change the web page.

Preferably, the storing step includes the step of correlating the user identifier with the web page readable or changeable by a user having the user identifier, and storing them in a table.

Thus, it becomes possible to ensure security, not on a web server basis, but on a web page basis. Further, it becomes unnecessary for a user to perform painstaking, intricate operations including inputting the user ID and password for every web page.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an entire configuration of a login authentication system according to an embodiment of the present invention.

FIG. 2 is a flow chart illustrating an operation of the login authentication system when a user attempts to access a web page using a terminal 10 located off the premises where the system exists.

FIG. 3 is a flow chart illustrating an operation of the login authentication system when a user attempts to access a web page using a terminal 1 located on the premises where the system exists.

### DESCRIPTION OF THE PREFERRED EMBODIMENTS

Hereinafter, embodiments of the present invention will be described in detail with reference to the accompanying drawings, throughout of which the same reference characters represent the same or corresponding portions, and description thereof will not be repeated where appropriate.

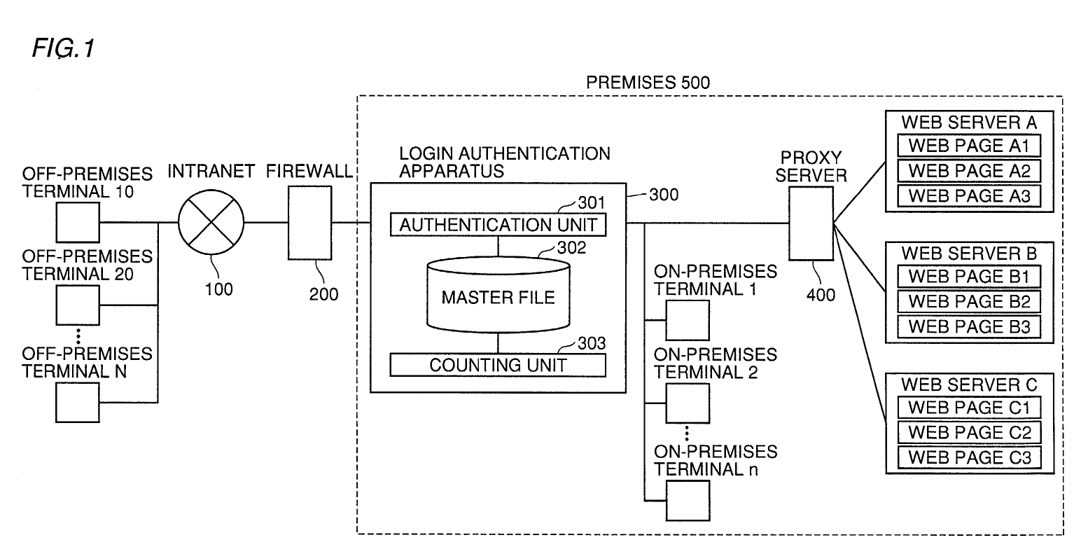

Referring to FIG. 1, a login authentication apparatus 300 is located on the premises 500. Herein, the premises refer to a respective factory, business office, or any combination thereof, as a unit of business in a company. Login authentication apparatus 300 is connected via a firewall 200 and an intranet 100 to terminals 10-N located outside the relevant premises (hereinafter, referred to as “off-premises terminals”).

Inside the premises 500, login authentication apparatus 300 is connected to terminals 1-n located on the premises (hereinafter, referred to as “on-premises terminals”) and a proxy web server 400. Proxy web server 400 can be connected to a web server A having web pages A1-A3, a web server B having web pages B1-B3, and a web server C having web pages C1-C3. Although three web servers are shown as connected to proxy web server 400 in FIG. 1, it is of course possible to connect more than three web servers to proxy web server 400.

Login authentication apparatus 300 includes an authentication unit 301, a master file 302 and a counting unit 303.

Master file 302 stores, in an authentication table as shown in Table 1, user IDs and passwords as identifiers of users who have access to respective web pages A1-A3, B1-B3, C1-C3 within respective web servers A-C.

TABLE 1

| | | Web pages allowed to access or | | | | | | | | | Personnel/corporate | | |
|---|---|---|---|---|---|---|---|---|---|---|---|---|---|
| | | allowed to access and change | | | | | | | | | ladder information | | |
| | | Server A | | | Server B | | | Server C | | | Factory | Dept | Section |
| User ID | Password | A1 | A2 | A3 | B1 | B2 | B3 | C1 | C2 | C3 | code | code | code |
| A001 | XX010 | | ◯ | ● | | | | | | | KUMA | AXX | 100 |
| | Number of accesses | | 126 | 59 | | | | | | | | | |
| A002 | AAb1 | ◯ | | | | | | | | | KUMA | BXX | 200 |
| | Number of accesses | 15 | | | | | | | | | | | |
| B003 | C026 | | ● | | ● | ◯ | | | | | ITAMI | YXX | 300 |
| | Number of accesses | | 50 | | 48 | 10 | | | | | | | |
| B004 | ax9935x3 | | | | | | | ● | | | FUKU | SXX | 400 |
| | Number of accesses | | | | | | | 300 | | | | | |

In Table 1, ● shows that the relevant user is allowed not only to access the relevant web page but also to change or update its content. ◯ shows that the user is allowed to access the web page, but is prohibited to change or update the content. For example, in Table 1, a user having a user ID of A001 is allowed to access web page A2, but is not allowed to change or update the content thereof. The same user is allowed to access web page A3, and also allowed to change or update the content thereof. The same user is prohibited to access any other web pages, or change or update the contents thereof.

In the authentication table, factory code, department code and section code are registered for a respective user ID as personnel affairs and corporate ladder information, to indicate affiliation of the relevant user.

The number of accesses to a respective web page by each user is also recorded, as shown in Table 1.

When a user attempting to access a certain web page in any of web servers A-C transmits his/her user ID and password from any of off-premises terminals 10-N and on-premises terminals 1-n, authentication unit 301 within login authentication apparatus 300 compares the received user ID and password with user IDs and passwords in the authentication table stored in master file 302, and determines whether the user is allowed to access the relevant web page and/or change the content thereof as desired.

Counting unit 303 within login authentication apparatus 300 has functions of counting the number of accesses made by respective users to respective web pages, and regularly summing up or compiling the counted results for each corporate ladder.

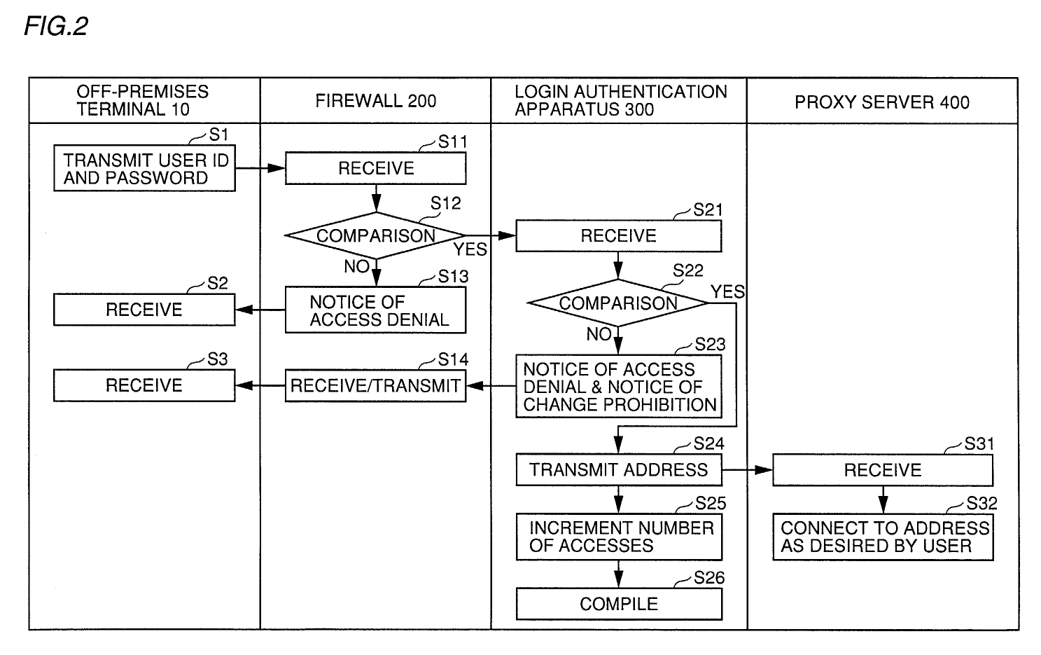

An operation of the login authentication system shown in FIG. 1 in the case where a user attempts to access a web page from off-premises terminal 10 will now be described with reference to a flow chart in FIG. 2.

Referring to FIG. 2, suppose that a user uses off-premises terminal 10 to access web page A2 of web server A on the premises 500. In this case, the user enters corresponding user ID and password and an address of web page A2 he/she attempts to access into off-premises terminal 10 via an input unit (not shown), including keyboard and mouse, to transmit them to login authentication apparatus 300 located on the premises 500 (step S1).

The user ID and password as well as the address of web page A2 are transmitted via intranet 100 and received at firewall 200 (step S11).

Firewall 200 is a system that is provided to screen illegal accesses from off-premises terminals 10-N to web servers A-C on the premises 500. User IDs and passwords accessible to web servers A-C on the premises 500 are registered in advance within firewall 200, with which the user ID and password transmitted from off-premises terminal 10 are compared (step S12).

As a result of comparison in step S12, if the user ID and password received from off-premises terminal 10 do not match those pre-registered in firewall 200, firewall 200 sends to off-premises terminal 10 a notice indicating that the access was denied (“notice of access denial”) (step S13). This notice is forwarded via intranet 100 and received at off-premises terminal 10 (step S2).

On the other hand, as a result of comparison within firewall 200, if the user ID and password transmitted from off-premises terminal 10 match those pre-registered in firewall 200, firewall 200 forwards the user ID and password as well as the address of web page A2 received from off-premises terminal 10 to login authentication apparatus 300 located on the premises 500 (step S12).

When login authentication apparatus 300 receives the user ID and password and the address of web page A2 from firewall 200 (step S21), authentication unit 301 within the login authentication apparatus 300 determines whether the received user ID and password match those in the authentication table and further determines whether the relevant user is accessible to web page A2 as desired (step S22). This authentication is done using the authentication table as shown in Table 1, which is stored in master file 302.

At this time, if the user ID and password do not match those in the authentication table, the notice of access denial is transmitted indicating that access to the web server on the premises 500 was denied (step S23). This notice is transmitted via firewall 200 (step S14) and received at off-premises terminal 10 (step S3).

Further, even if the user ID and password match those in the authentication table, the relevant user cannot access web page A2 unless he/she has been registered as accessible to web page A2 in the authentication table.

For example, if a user attempting to access web page A2 from off-premises terminal 10 has a user ID of A001, the user is accessible to web page A2 as ◯ is correspondingly recorded in the authentication table, as shown in Table 1. However, if the user has a user ID of A002, ◯ is not recorded for the user corresponding to web page A2 in the authentication table. Thus, the user having the user ID of A002 is allowed to connect to the web servers on the premises 500, but is not allowed to access web page A2. Accordingly, again in this case, the notice of access denial is transmitted to off-premises terminal 10 from which the user having the user ID of A002 attempted to access web page A2 (step S23).

If authentication unit 301 determines that a user, e.g., the one having the user ID of A001, is accessible to web page A2, the address of web page A2 is transmitted to proxy web server 400 (step S24). Proxy web server 400, upon receipt of the address of web page A2 (step S31), allows the relevant user to access the web page as desired (step S32).

A user may attempt to change or update the content of web page A2. In this case, again, authentication unit 301 determines whether the user is allowed to change or update the content of web page A2. For example, in the authentication table shown in Table 1, ◯ is recorded for a user having the user ID of A001 corresponding to web page A2. Thus, the user has access to web page A2 but is not allowed to change or update the content thereof. Accordingly, if the user having the user ID of A001 tries to change or update the content of web page A2 using an input unit (not shown), including keyboard and mouse, of off-premises terminal 10, a notice indicating that he/she is prohibited to change the content (“notice of change prohibition”) is transmitted from login authentication apparatus 300 via firewall 200 and intranet 100 to off-premises terminal 10 (steps S23, S14 and S3).

If a user having the user ID of B003 tries to change or update the content of web page A2, however, ● has been recorded for the user corresponding to web page A2 in the authentication table as shown in Table 1. Therefore, authentication unit 301 determines that the user is allowed to change or update the content of web page A2, and transmits the address of web page A2 as well as information indicating that the change or update of the content thereof is permitted, to proxy web server 400 (step S24).

After the address of the web page which the user attempts to access is transmitted to proxy web server 400, counting unit 303 within login authentication apparatus 300 increments, by 1, the number of accesses to the relevant web page by the relevant user (step S25). The numbers of accesses counted are recorded in the authentication table, e.g., as shown in Table 1.

Further, counting unit 303 sums up or compiles the numbers of accesses to respective web pages for each factory code, department code and section code, employing another authentication table form as shown in Table 2 (step S26). The compiled results are shown in Table 2.

TABLE 2

| | | Number of accesses to web pages | | | | | | | | |
|---|---|---|---|---|---|---|---|---|---|---|
| | | Server A | | | Server B | | | Server C | | |
| | | A1 | A2 | A3 | B1 | B2 | B3 | C1 | C2 | C3 |
| Factory | KUNA | 100 | 250 | 23 | 55 | 78 | 95 | 12 | 62 | 91 |
| code | ITAMI | 11 | 50 | 47 | . . . | . . . | . . . | . . . | . . . | . . . |
| | FUKU | . . . | . . . | . . . | . . . | . . . | . . . | . . . | . . . | . . . |
| | . . . | . . . | . . . | . . . | . . . | . . . | . . . | . . . | . . . | . . . |
| Dept | AXX | 75 | 225 | 26 | 30 | 53 | 70 | 15 | 37 | 66 |
| code | BXX | . . . | . . . | . . . | . . . | . . . | . . . | . . . | . . . | . . . |
| | . . . | . . . | . . . | . . . | . . . | . . . | . . . | . . . | . . . | . . . |
| Section | 100 | 15 | 165 | 5 | 0 | 28 | 10 | 0 | 2 | 6 |
| code | 200 | . . . | . . . | . . . | . . . | . . . | . . . | . . . | . . . | . . . |
| | . . . | . . . | . . . | . . . | . . . | . . . | . . . | . . . | . . . | . . . |

Thus, it becomes possible to readily confirm accesses to web pages on a factory, department or section basis within the company. This enables arrangement and fulfillment of the contents of respective web pages in accordance with their availability.

The operation of the login authentication system in the case where the user uses one of off-premises terminals 10-N has been described. The login authentication system also operates when the user uses one of the terminals 1-n on the premises 500.

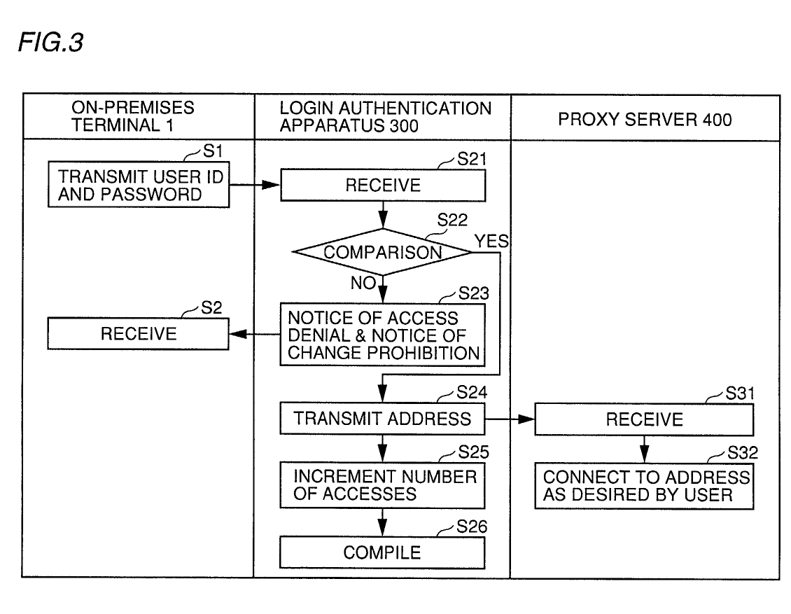

An operation of the login authentication system in the case where a user uses one of on-premises terminals 1-n to access a web page will now be described with reference to a flow chart in FIG. 3.

Referring to FIG. 3, suppose that the user uses on-premises terminal 1 to access web page A2 of web server A on the premises 500. In this case, the user enters corresponding user ID and password and an address of web page A2 into on-premises terminal 1 via an input unit (not shown) including keyboard and mouse, to transmit them to login authentication apparatus 300 (step S1).

When login authentication apparatus 300 receives the user ID and password and the address of web page A2 from on-premises terminal 1 (step S21), authentication unit 301 determines whether the received user ID and password match any of the user IDs and passwords in the authentication table, and further determines whether the user is allowed to access web page A2 as desired (step S22). This authentication is done using the authentication table, as shown in Table 1, stored in master file 302.

The authentication method of authentication unit 301 in this case is the same as described in connection with the operation of the login authentication system as shown in Table 2, and therefore, description thereof is not repeated.

If authentication unit 301 determines that the access from on-premises terminal 1 to web page A2 is not allowed, login authentication apparatus 300 transmits the notice of access denial directly to on-premises terminal 1 (step S23), and on-premises terminal 1 receives the notice (step S2).

The operation in the case where authentication unit 301 allows access from on-premises terminal 1 to web page A2 is identical to the operation as illustrated in FIG. 2, corresponding to step S24 and the succeeding steps. Therefore, description thereof is not repeated.

As explained above, according to the present invention, provision of login authentication apparatus 300 allows assuring of security on a web page basis. Furthermore, a user is free from complicated and laborious operations including inputting the user ID and password every time he/she attempts to access respective web servers and web pages.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A login authentication apparatus connectable to a terminal and a web server through an intranet, comprising:
a storage unit storing a user identifier, an address of a web page within the web server readable by a user having said user identifier, and an address of a web page within the web server changeable by a user having said user identifier; and
an authentication unit comparing a user identifier received from said terminal with the user identifier stored in said storage unit to determine whether a user having the user identifier received from said terminal is allowed to read said web page and whether the same user is allowed to change said web page.

2. The login authentication apparatus according to claim 1, wherein said storage unit correlates said user identifier with said readable or changeable web page to store in a table.

3. The login authentication apparatus according to claim 2, further comprising:
a compiling unit counting a number of access to each said web page and compiling the counted number for each attribute of said identifier as access information,
wherein said storage unit stores said access information.

4. A login authentication method employing a login authentication apparatus connectable to a terminal and a web server through an intranet, comprising the steps of:
storing a user identifier, an address of a web page within the web server readable by a user having said user identifier and an address of a web page within the web server changeable by a user having said user identifier; and
comparing a user identifier received from said terminal with the user identifier stored in said storing step to determine whether a user having the user identifier received from said terminal is allowed to read said web page and whether the same user is allowed to change said web page.

5. The login authentication method according to claim 4, wherein said storing step includes the step of correlating said user identifier with said readable or changeable web page to store in a table.

6. The login authentication method according to claim 5, further comprising the step of:
counting a number of access to each said web page and compiling the counted number for each attribute of said identifier as access information,
wherein said storing step includes the step of storing said access information.
